(19) United States
(12) Patent Application Publication
(10) Pub. No.: US 2008/0070459 A1
(43) Pub. Date: Mar. 20, 2008

(54) Construction laminates

(75) Inventor: Harvey Howells, Richardson, TX (US)

Correspondence Address: Jon D. Wood, Chief I.P. Counsel;Bridgestone Americas Holding, Inc., 1200 Firestone Parkway, Akron, OH, 44317, US

(73) Assignee: BFS DIVERSIFIED PRODUCTS, LLC

(21) Appl. No.: 11/986,773

(22) Filed: Nov. 26, 2007

Related U.S. Application Data
(63) Continuation of application No. 11/192,883, filed on Jul. 29, 2005.
(60) Provisional application No. 60/592,312, filed on Jul. 29, 2004.

(51) Int. Cl. B32B 5/18; B32B 27/32; B62D 29/04; B32B 3/26

(52) U.S. Cl. 442/22; 296/181.2; 428/304.4; 428/523

(57) ABSTRACT

A construction laminate comprising a first foam layer, a first reinforcing layer in contact with the foam layer, a second foam layer in contact with the first reinforcing layer and positioned opposite the first foam layer with respect to the first reinforcing layer, a second reinforcing layer in contact with the second foam layer and positioned opposite the first reinforcing layer with respect to the second foam layer, and a protective layer in contact with the second reinforcing layer.

This is a continuation of U.S. Ser. No. 11/192,883, filed Jul. 29, 2005, which is incorporated herein by reference, which itself claims the benefit of U.S. Provisional Application No. 60/592,312, filed Jul. 29, 2004.

### FIELD OF THE INVENTION

One or more embodiments of this invention relate to construction laminates and methods for making the same.

### BACKGROUND OF THE INVENTION

Prefabricated laminates are often used in the construction industry. These laminates may include a base layer that offers structural integrity and insulating value, and an external layer that provides protection from environmental exposure such as rain and UV light. Because these laminates may be pre-constructed, their use as building materials may facilitate construction and save overall costs.

In one particular use, prefabricated construction laminates may be employed in constructing the shell of recreational vehicles. A laminate employed for this use is shown in FIG. 1. The laminate 1 includes an external fiberglass layer 2, a first lauan plywood layer 3, an insulation layer 4, which includes tubular aluminum frame 5, and foamed polystyrene 6, a second lauan plywood layer 7, and an interior surface layer 8. The fiberglass layer 2 and first lauan layer 3 may be referred to as the exterior layer 9, and the insulation layer 4, second lauan layer 7, and interior surface layer 8 may be referred to collectively as the interior layer 10.

These laminates may be constructed at the location where the recreational vehicle is manufactured by adhering a plurality of 4′×8′ lauan sheets to a fiberglass sheet, which is typically about 30′×8′. The foamed styrene can then be adhered to the opposite side of the lauan so as to sandwich the lauan between the fiberglass and foamed polystyrene. The second lauan layer can be adhered to insulation layer (aluminum and polystyrene), and an interior covering, which is typically a vinyl material, can be adhered over the second lauan layer. In most conventional operations, the various layers may be adhered to one another by using a hot-melt urethane adhesive.

The use of these particular construction laminates can have several drawbacks. First, the laminates are rather heavy and therefore installation can be difficult. Also, the overall weight of the recreational vehicle may be unnecessarily increased by the relatively large weight of the laminates. The panels can be prone to dents, cracks, scratches and are difficult to repair. Additionally, because the lauan typically used is supplied in 4′×8′ panels, seams may be visible throughout the fiberglass covering. This problem can be overcome by using much thicker fiberglass than otherwise necessary, but this further increases the weight and cost of the laminate.

There is therefore a need to improve construction laminates, particularly those employed in constructing recreational vehicles.

### SUMMARY OF THE INVENTION

Certain embodiments of this invention provide a construction laminate comprising a first foam layer, a first reinforcing layer in contact with the foam layer, a second foam layer in contact with the first reinforcing layer and positioned opposite the first foam layer with respect to the first reinforcing layer, a second reinforcing layer in contact with the second foam layer and positioned opposite the first reinforcing layer with respect to the second foam layer, and a protective layer in contact with the second reinforcing layer.

Certain embodiments of this invention also provide a recreational vehicle comprising a wall including a construction laminate, where the laminate includes an exterior layer and an interior layer, where the external layer includes a protective cap, at least one foam layer, a first reinforcing layer contacting the foam layer, a second reinforcing layer, and a protective layer in contact with the second reinforcing layer.

Certain embodiments of this invention include a construction laminate comprising at least one foam layer, a reinforcing layer in contact with said at least one foam layer, and a protective layer.

Certain embodiments of this invention also include a process for forming an external composite construction laminate, the method comprising extruding a foam, contacting the foam to a scrim to form a reinforced foam, and extruding a thermoformable material onto the reinforced foam.

Certain embodiments of this invention further provide a process for forming a construction laminate, the process comprising coextruding a cap layer and a filled polymer layer to form a bilaminate, extruding a foam layer on the bilaminate.

Certain embodiments of this invention also provide a process for forming a construction laminate, the process comprising coextruding a cap layer and a filled polymer layer onto a foam layer.

### BRIEF DESCRIPTION OF THE DRAWINGS

FIG. 1 is a sectional view of a prior art construction laminate used for the construction of recreational vehicles.

FIG. 2 is a sectional view of the side of a construction laminate according to one or more embodiments of the invention.

FIG. 3 is a sectional view of one embodiment of a construction laminate exterior layer.

FIG. 4 is a sectional view of one embodiment of a construction laminate exterior layer.

FIG. 5 is an elevational view of a reinforcing scrim useful in the invention.

FIG. 6 is a sectional view of a construction laminate of one or more embodiments of the present invention.

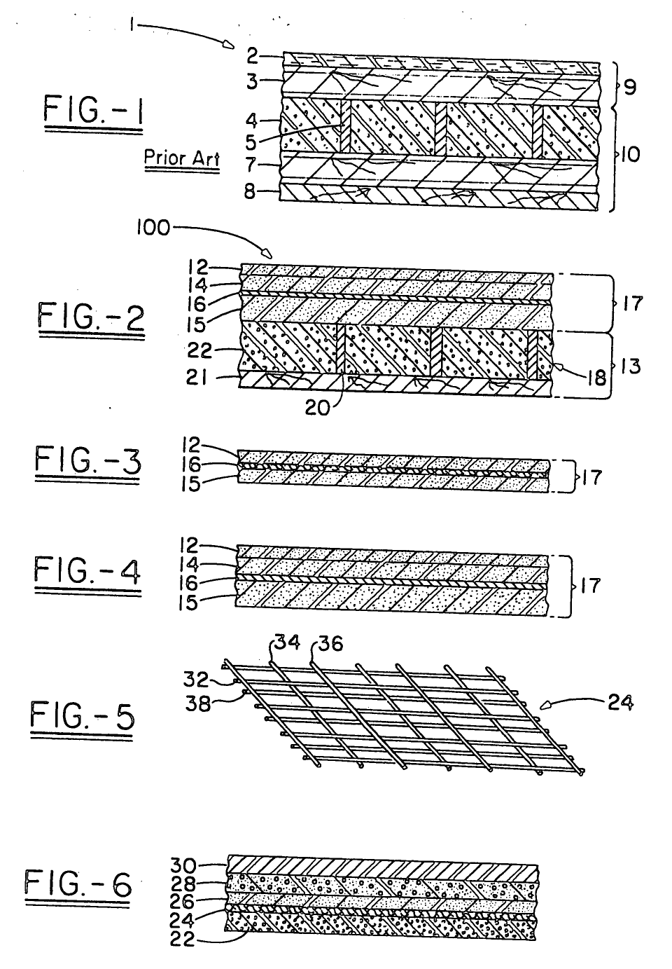

### DETAILED DESCRIPTION OF ILLUSTRATIVE EMBODIMENTS

The construction laminates of one or more embodiments of this invention may be used in constructing recreational vehicles. In one or more embodiments, these construction laminates may be included in the exterior shell or siding of a recreational vehicle. The exterior shell or siding of a recreational vehicle may include both an exterior portion and an interior portion. In one or more embodiments, the laminates of this invention may form the exterior portion of the shell. Accordingly, the construction laminates of this invention may be included in combination with an interior portion of a recreational vehicle siding or shell construction. For example, as shown in FIG. 2, siding or shell 100, which itself may be referred to as a laminate, includes an exterior portion or layer 17 and an interior portion or layer 13. Exterior portion 17 includes a protective layer 12, foam layers 14 and 15, and a reinforcing layer 16. Interior portion 13 includes an insulation layer 18, which may include a frame 20 and an insulating material 22, and an interior surface layer 21. In certain embodiments, exterior portion 17, which includes the protective layer 12, foam layers 14 and 15, and reinforcing layer 16, may be prepared in a continuous process.

The terms interior and exterior are employed merely to distinguish portions 13 and 17. As the construction laminates relate to the outer shell or siding of a recreational vehicle, the terms interior and exterior may relate to the positioning of portions 13 and 17 with respect to the vehicle; in other words, the exterior portion 17 can form the outermost layers of the siding of a recreational vehicle, and interior portion 17 can form the innermost layers of the shell or siding of a recreational vehicle.

In one embodiment, as shown in FIG. 2, protective layer 12 can be positioned adjacent to first foam layer 14, reinforcing layer 16 can be in contact with foam layers 14 and 15, insulation layer 18 can be positioned adjacent to second foam layer 15 opposite to protective layer 12, insulating material 22 can be positioned within the interstices of frame 20, and interior surface layer 24 can be positioned adjacent to frame 18 opposite to foam layer 15.

In one embodiment, reinforcing layer 16, as shown in FIGS. 3 and 4, can be positioned at or near the center or midpoint of the width of exterior layer 17. Accordingly, thickness of first foam layer 14 may change depending on the thicknesses of second foam layer 15 and protective layer 12. For example, and as exemplified in FIG. 3, second foam layer 15 and protective layer 12 have a similar thickness, and therefore reinforcing layer 16 can be positioned near the surface of second foam layer 15 and can be in contact with protective layer 12, and first foam layer 14 is substantially absent. Alternatively, and as exemplified in FIG. 4, second foam layer 15 can be substantially thicker than protective layer 12. As a result, reinforcing layer 16 can be positioned between first foam layer 14 and second foam layer 15. The thickness of second foam layer 15 can be about equal to the sum of the thicknesses of first foam layer 14 and protective layer 12.

Another embodiment of a construction laminates according to the present invention is shown with respect to FIG. 6. Laminate 20 includes first foam layer 22, first reinforcing layer 24, optional second foam layer 26, second reinforcing layer 28, and exterior cap layer 30. In one or more embodiments, first foam layer 22 is adjacent to first reinforcing layer 24, first reinforcing layer 24 is adjacent to second foam layer 26, second foam layer 26 is adjacent to second reinforcing layer 28, and second reinforcing layer 28 is adjacent to exterior cap layer 30. In one or more embodiments, laminate 20 may form the exterior layer or portion of a siding panel. For example, and with reference to FIG. 2, the laminate of FIG. 6 may be connected to interior portion 13 to form a siding panel.

Protective layer or cap layer 12 (or in other embodiments cap layer 30) includes a thermoplastic or thermoset material. In one or more embodiments, protective layer 12 includes an extrudate of a thermoplastic or thermoformable material, which refers to a material that can be processed as a thermoplastic material.

Useful thermoplastic resins include poly α-olefins such as, but not limited to, polyethylene or polypropylene, as well other thermoplastics such as polystyrene, acrylic resins such as, but not limited to, polymers or copolymers of acrylic acid, methacrylic acid, esters of these acids, acrylonitrile, or combinations thereof.

In one embodiment, the thermoplastic or thermoformable material includes a polymeric blend of a poly α-olefin and an acrylic resin. These blends may include from about 30 to about 80% by weight, in other embodiments from about 40 to about 70% by weight, and in other embodiments from about 45 to about 60% by weight poly α-olefin, and from about 70 to about 20% by weight, in other embodiments from about 60 to about 30% by weight, and in other embodiments from about 55 to about 40% by weight acrylic resin.

In one embodiment, the thermoplastic or thermoformable material includes a copolymer, including graft copolymers, of polypropylene and acrylic resins. For example, graft copolymers including an isotactic-polypropylene backbone having grafted thereto polystyrene, polyvinylacetate, polymethacrylate, polymethylmethacrylate, polyacrylonitrile, or a mixture thereof. In one or more embodiments, graft copolymers include from about 30 to about 70% by weight poly α-olefin and from about 70 to about 30% by weight acrylic resin, and in other embodiments from about 40 to about 60% by weight poly α-olefin and from about 60 to about 40% by weight acrylic resin. Useful graft copolymers include those disclosed in U.S. Pat. No. 6,617,410, which is incorporated herein by reference. Useful graft copolymers include those that are commercially available under the tradename Interloy™ W1095H1 (Crompton).

The thickness of protective layer 12 (or layer 30) may be from about 150 mils to about 20 mils, in other embodiments less than about 100 mils, and in other embodiments from about 100 mils to about 30 mils.

In one or more embodiments, foam layers 14 and 15 (or in other embodiments foam layers 22 and 26) may include a rigid, closed-cell foam. In one embodiment, most of the cells of the closed-cell foam have intact cell membranes. Each of the various foam layers may be the same or different. The bulk density of the foam may be from about 0.6 cm³ to about 0.9 cm³, in other embodiments from about 0.70 cm³ to about 0.85 cm³, and in other embodiments from about 0.63 cm³ to about 0.70 cm³. The closed cell content of the foam can be at least about 15%, in other embodiments at least about 20%, and in other embodiments at least about 30% of the cells.

The sum of the thicknesses of foam layers 14 and 15 (or layers 22 and 26) can be from about 45 mils to about 85 mils, in other embodiments from about 50 mils to about 80 mils, and in other embodiments from about 60 mils to about 70 mils.

The cellular material of the foam layer may be a thermoplastic or a thermoset polymer. Suitable polymers include polyurethane, polyisocyanurate, phenolic resin, rubber, polybutadiene, polyvinyl chloride, polyisoprene, urea-aldehyde, melamine-aldehyde, polystyrene, polyethers, polyimides, polysulphones, polycarbonates, polyetherimides, polyamides, polyesters, silicate resins, polyacetal resins, polyhydantoins, polyvinylidene chloride, polymethyl-methacrylate, poly α-olefins such as polypropylene and polyethylene, polytetrafluoro-ethylene, cellulose acetate, epoxy, acrylonitrile-butadiene-styrene copolymer, silicone, and mixtures thereof.

The cells of the foam may include an insulating agent, which may also be referred to as a blowing agent. Useful blowing agents include azodicarbonamide (commercially available under the tradename Celogen™), alkanes, cycloalkanes, hydrofluorocarbons, hydrochlorofluorocarbons, fluorocarbons, fluorinated ethers, alkenes, alkynes, noble gases, nitrogen, carbon dioxide, water, and mixtures thereof.

The cellular material may also include conventional auxiliary agents that are used in foam materials. Useful auxiliary agents or additives include processing aids, viscosity reducers, flame retardants, dispersing agents, plasticizers, antioxidants, compatibility agents, fillers, and pigments.

Reinforcing layer 16 (or in other embodiments layers 24 and/or 28) may include a scrim or a reinforcing polymeric layer. Where multiple reinforcing layers are included, such as shown in FIG. 6, the two or more reinforcing layers may include a scrim reinforcement; or in other embodiments, the two or more reinforcing layers may include a polymeric layer; and in other embodiments, a first reinforcing layer may include a polymeric layer, and a second reinforcing layer may include a scrim. In one particular embodiment, as shown in FIG. 6, first reinforcing layer 24 may include a scrim, and second reinforcing layer 28 may include a polymeric layer.

Useful scrims include woven and non-woven scrims, directional and non-directional scrims, and orthogonal and non-orthogonal scrims. Useful scrims may include conventional scrims, which include a plurality of yarns oriented in the machine direction, or along the length of the scrim, and a plurality of yarns oriented in the cross-machine direction, or across the width of the scrim. These yarns may be referred to as the warp yarns and weft yarns, respectively.

Numerous yarns can be employed including, but not limited to, fibrous materials, metals, and polymers. For example, the yarns can include, but are not limited to, fiberglass, aluminum, or aromatic polyamide polymers (e.g., Kevlar).

In one embodiment, the scrim includes fiberglass yarns. Fiberglass yarns may be characterized by about 150 1/0 to about 18 1/0 (330 decitex to about 2640 decitex), and in other embodiments about 37 1/0 (1320 decitex).

The scrims may be adhered together or locked into position using conventional binders such as crosslinkable acrylic resins, polyvinyl alcohol, or similar adhesives. The scrims may also be mechanically entangled by employing techniques such as, but not limited to, needle punching. In yet another embodiment, the scrims can be locked into place by weaving.

In one particular embodiment, reinforcing layer 16 includes a fiberglass non-woven scrim as shown in FIG. 5. Scrim 30 includes a first plurality of yarns 32 positioned in a first plane. Scrim 30 also includes a second plurality of yarns 34 positioned within a second plane, a third plurality of yarns 36 positioned in a third plane, and a fourth plurality of yarns 38 positioned in a fourth plane. First plurality of yarns 32 and fourth plurality of yarns 38 extend longitudinally along the length of the laminate. Second plurality of yarns 34 and third plurality of yarns 36 generally extend laterally across the laminate at angle α to the first plurality of yarns 32. In one embodiment, angle α is from about 20 to about 70 degrees and in other embodiments from about 40 to about 50 degrees. The yarns are preferably adhered to one another using a binder such as a polyvinyl alcohol binder.

In another embodiment, the reinforcing layer may include an alternate fiberglass scrim. This fiberglass scrim may include a first plurality of yarns positioned in a first plane, a second plurality of yarns positioned in a second plane, and a third plurality of yarns positioned in a third plane. The First plurality of yarns and the third plurality of yarns extend longitudinally along the length of the laminate. The second plurality of yarns generally extends laterally across the laminate at angle α to the first plurality of yarns. Angle α may generally from about 20 to about 70 degrees, and preferably from about 40 to about 45 degrees. The configuration of second plurality of yarns results from a cross-lap structure. Specifically, a plurality of yarns are folded in an accordion fashion to form angle α across the width of the layer and folded back across the width at a similar angle so as to ultimately achieve complete coverage through the entire length of the layer.

Useful scrims include those that are commercially available. For example, fiberglass scrims are available under the tradename STYLE™ 930120 (Milliken & Co.; Spartanburg, S.C.) and also available from JP Stevens (Greenville, S.C.). Aluminum scrims are commercially available as Pfifer Wire aluminum screen door stock (Phifer Wire Products, Inc.; Tuscaloosa, Ala.).

In one or more embodiments, one or more of the reinforcing layers (e.g., reinforcing layers 16, 24, or 28) may include a polymeric layer in lieu of a scrim. These reinforcing polymeric layers can be characterized by a coefficient of linear thermal expansion (CLTE), as measured by ASTM D-696, of less than 2.5×10⁻⁵, in other embodiments less than 2.4×10⁻⁵, in other embodiments less than 2.3×10⁻⁵, and in other embodiments less than 2.1×10⁻⁵.

The thickness of polymeric reinforcing layer 24 and/or 28 may be from about 5 to about 100 mils, in other embodiments from about 10 to about 70 mils, and in other embodiments from about 20 to about 40 mils.

In one or more embodiments, the polymeric reinforcing layer may include a polymeric material and a filler that serves to lower the CLTE of the polymeric layer. The filler may be dispersed throughout the polymeric layer, with the polymeric material serving as a matrix for the filler. Useful fillers include calcium carbonate, graphite, glass beads, silica, and clay microspheres (nanocomposites). The polymeric material that can serve as the matrix of the polymeric layer may include a thermoplastic material. In one or more embodiments, the thermoplastic material may be compatible with the cap layer (e.g., cap layer 12 or 30); and in other embodiments, the thermoplastic material can also be compatible with the foam layers (e.g., foam layer 15 or foam layer 22 and 26). In one or more embodiments, this compatibility includes the ability of the polymeric material to adhere to the cap layer and/or foam layer. Examples of useful polymeric materials include polypropylene and propylene-based copolymers. Useful propylene-based copolymers include those copolymers of propylene and a comonomer such as ethylene or higher α-olefins such as butene-1, pentene-1, hexene-1, heptane-1, and octene-1.

Filled polymeric materials that may be useful for forming the polymeric reinforcing layer of the present invention are commercially available. For example, filled polymers are available under the name SEQUEL™ (Solvay) and CURVE™ (Amoco).

Frame 20 may be fabricated from a variety of materials including wood, metal, and polymers. In one embodiment, the frame includes hollow-aluminum tubing such as square bore stock 2 inch aluminum box.

Insulating material 22 may be positioned within the interstices of frame 20. A variety of insulating materials, which are known in the art, may be employed in practicing the invention. Useful insulating materials include expanded thermoplastic materials such as expanded polyethylene, expanded polypropylene, and expanded polystyrene. Expanded thermosetting resins may also be employed such as polyurethane foams and polyisocyanurate foams. Still further, useful insulating materials include fibrous materials such as fiberglass and cellulose.

In another embodiment, insulation layer 18 does not include frame 20. Instead, insulating material 22 includes a rigid material that obviates the need for a frame. For example, the insulating material may include a rigid polyurethane or polyisocyanurate foam board.

A variety of materials can be used to form the interior surface layer 21. As is known in the art, various synthetic materials can be employed to create surfaces that are aesthetically pleasing and optionally provide resistance to environmental factors typically experienced indoors or to an interior. For example, vinyl films or fabrics can be manufactured to have an aesthetically pleasing appearance and provide a certain level of stain and wear resistance. Other materials or substances that may be employed to form the interior surface layer 24 include coverings such as wall paper, wall coverings, panel. Useful panel is available under the trade name Tambour™ (National Products, L.L.C., Louisville, Ky.). Wall coverings are available under trade names such as Bolta™ or Essex™ (Omnova Solutions, Inc., Fairlawn, Ohio). Wall paper is available under various trade names such as Arabella SW9RA1807 (The Sherwin-Williams Company, Cleveland, Ohio).

In one embodiment, exterior portion 17 (i.e., protective layer 12, foam layers 14 and 15, and reinforcing layer 16) may be produced in a continuous process. In one embodiment, the cellular material of foam layers 14 and 15 (i.e., the polypropylene) are extruded from an extrusion die to form a foam. The extrusion apparatus and dies that can be used in forming the foam are conventional and well known in the art. Various foaming agents can be employed as noted above. As the foam expands while leaving the die, the expanding foam can be contacted with the reinforcing layer. In one embodiment, a scrim can be vertically fed between two vertically positioned dies. The foam and scrim can then fed through a series of rolls such as first roll, second roll, third roll, and forth roll, which are mounted on hydraulic arms that are positioned apart at the desired width of the exterior layer. At a location downstream from where the foam and scrim layers are contacted, such as between third roller and forth roller, an extrusion die can be positioned adjacent to the foam and scrim product. Protective layer 12 can be extruded through this die onto the scrim and foam product by using conventional extrusion techniques. The resultant product can be fairly flexible and can be wound into rolls that advantageously can extend up to 250 m. Also, the construction laminates can advantageously be produced to a width up to about 4 m.

In one or more embodiments, the laminate may be formed by coextruding the cap layer and the polymeric reinforcing layer. For example, with reference to FIG. 6, cap layer 30 and reinforcing layer 28 can be co-extruded where reinforcing layer 28 includes an extrudable polymeric material (e.g., a filled polymer). In one or more embodiments, the coextrusion of these thermoformable materials forms an integral laminate. This laminate can then be used as a platform or base upon which the foam can be extruded. Alternatively, the foam can first be formed followed by coextrusion of the reinforcing and cap layers.

In manufacturing the siding panels, which include both the exterior and interior portions, the exterior portion (e.g., laminate 20 of FIG. 6) can be fastened or adhered to an interior portion (e.g., foam and insulation) by using conventional fastening devices or adhesives. In one or more embodiments, the exterior portion can be adhered to the interior portion by using a reactive hot melt adhesive such as a moisture curable polyurethane.

Depending on the protective cap employed, certain embodiments of this invention are advantageously scratch and dent resistant. Also, in certain embodiments, the construction laminates are particularly easy to repair by classic heat welding. Further, certain embodiments are color-fast in direct sunlight and have advantageous weatherability. The final product of certain embodiments may also be seamless.

Also, the construction boards of certain embodiments may be lighter in weight than those construction laminates employed in the prior art. For example, in certain embodiments of this invention, exterior layer 17 (i.e., the protective layer 12, the foam layer 14, and the reinforcing layer 16), may be characterized by having a density of less from about 1.5 g/m² to about 0.7 g/m², in other embodiments from about 0.95 g/m² to about 0.75 g/m², and in other embodiments about 0.85 g/m². Also, in certain embodiments, exterior layer 17 can advantageously be characterized by having a width from about 1.5 to about 0.7 mils, in other embodiments from about 0.95 to about 0.75 mils, and in other embodiments from about 0.90 to about 0.80 mils, and most preferably about 0.85 mils.

The laminates of certain embodiments of this invention can survive the falling dart impact test such that when a weighted dart is dropped from two inches, the laminate will not allow leaks of fluids such as water when the falling dart is weighted to about 80 pounds, and in certain instances when the dart is weighted to about 140 pounds. In certain embodiments, layer 12 has no noticeable color shift after 500 hours of weatherability test.

In one particular embodiment, the construction laminate of the present invention includes a polypropylene foam layer, a fiberglass scrim reinforcing layer, and a protective cap that includes a polypropylene-acrylic resin grafted copolymer. Useful scrims include those that are commercially available under the tradename Style™ 930120 (Milliken & Co.; Spartanburg, S.C.) and the polypropylene-acrylic resin grafted copolymer is commercially available under the tradename Interlay™ W1095H1.

The construction laminates of this invention are particularly useful for forming the walls of recreational vehicles. Recreational vehicles include motor homes, trailers, boats, pick-up truck campers and hybrid camping trailers. The construction laminates of this invention can also be used to fabricate the exterior of a truck trailer.

Various modifications and alterations that do not depart from the scope and spirit of this invention will become apparent to those skilled in the art. This invention is not to be duly limited to the illustrative embodiments set forth herein.

What is claimed is:

1. A recreational vehicle construction laminate comprising:
a thermoformable layer;
a protective layer; and
a reinforcing layer positioned between said thermoformable layer and said protective layer;
where said thermoformable layer, said protective layer and said reinforcing layer are laminated together to form an all composite construction laminate and where said construction laminate forms an exterior portion of an outer shell panel of a recreational vehicle.

2. The construction laminate of claim 1, where said thermoformable layer is comprised of a thermoplastic polymer.

3. The construction laminate of claim 2, where said thermoplastic polymer is polypropylene.

4. The construction laminate of claim 1, where said thermoformable layer is foam.

5. The construction laminate of claim 1, where said thermoformable layer includes a filler dispersed therein.

6. The construction laminate of claim 1, where said protective layer is a thermoformable resin.

7. The construction laminate of claim 1, where said reinforcing layer includes a scrim.

8. The construction laminate of claim 7, where said scrim is a fiberglass scrim.

9. A recreational vehicle comprising:
at least two wheels located on opposing ends of a common axis; and
a shell having a floor, a roof, and sidewalls, where at least one sidewall includes an interior layer, an insulation layer, and an exterior layer;
where said insulation layer is positioned between said interior layer and said exterior layer and includes an insulating foam and metal frame members; and
where said exterior layer comprises a thermoformable protective layer and a reinforcing layer including fiberglass, said reinforcing layer being positioned between said insulation layer and said thermoformable protective layer.

10. The recreational vehicle of claim 9, where said exterior layer is adhered to said metal frame members of said insulation layer.

11. The recreational vehicle of claim 9, where said exterior layer is made of all composite materials.

12. The construction laminate of claim 9, where said exterior layer includes a thermoformable layer that is positioned between said insulation layer and said reinforcing layer.

13. The construction laminate of claim 12, where said thermoformable layer is polypropylene.

14. The construction laminate of claim 12, where said thermoformable layer is foam.

15. The construction laminate of claim 12, where said exterior layer includes a second thermoformable layer that is positioned between said protective layer and said reinforcing layer.

16. The construction laminate of claim 15, where said second thermoformable layer is polypropylene.

17. The construction laminate of claim 15, where said second thermoformable layer is foam.

18. The construction laminate of claim 12, where said thermoformable layer includes a filler.

19. The construction laminate of claim 9, where said protective layer is a thermoformable resin.

20. The construction laminate of claim 9, where said reinforcing layer includes a scrim.

21. The construction laminate of claim 9, where said reinforcing layer includes a polymeric layer.

22. The construction laminate of claim 9, where said protective layer is an acrylic resin.

23. The construction laminate of claim 9, where said protective layer is a blend of a poly α-olefin and an acrylic resin.

24. The construction laminate of claim 9, where said protective layer includes graft copolymers of polypropylene and acrylic resins.

25. The construction laminate of claim 9, where said protective layer includes an isotactic polypropylene backbone having grafted thereto polystyrene, polyvinylacetate, polymethacrylate, polymethylmethacrylate, polyacrylonitrile, or a mixture thereof.
